(19) United States
(12) Patent Application Publication
(10) Pub. No.: US 2012/0282942 A1
(43) Pub. Date: Nov. 8, 2012

(54) METHODS, APPARATUSES AND COMPUTER PROGRAM PRODUCTS FOR CONFIGURING FREQUENCY AGGREGATION

(75) Inventors: Mikko Aleksi Uusitalo, Helsinki (FI); Mika Petri Olavi Rinne, Espoo (FI); Antti Sakari Sorri, Helsinki (FI); Carl Simon Wijting, Espoo (FI); Claudio Rosa, Randers (DK)

(73) Assignees: Nokia Siemens Networks Oy; Nokia Corporation

(21) Appl. No.: 13/099,019

(22) Filed: May 2, 2011

(51) Int. Cl. H04W 72/00

(52) U.S. Cl. 455/452.2

(57) ABSTRACT

An apparatus for determining whether to deactivate a secondary cell includes a processor and memory storing executable computer program code that cause the apparatus to at least perform operations including determining that a secondary cell should be deactivated based on a measurement(s) of the secondary cell or received information associated with frequency spectrum of the secondary cell. The computer program code may cause the apparatus to generate a deactivation message responsive to the measurement(s) indicating secondary cell interference or the received information indicating that the apparatus should no longer use the frequency spectrum. The computer program code may cause the apparatus to provide the deactivation message to a network device. Corresponding methods and computer program products are also provided.

### TECHNOLOGICAL FIELD

An example embodiment of the invention relates to the field of wireless communications and, more particularly relates to a method, apparatus and computer program product for configuring frequency aggregation in a cellular communication system.

### BACKGROUND

Modern wireless telecommunication systems aim to provide efficient utilization of the available frequency spectrum so as to maximize capacity and throughput. Multiple systems or sub-systems may even be allocated to share a common frequency band which may be shared in a dynamic manner between the systems. Such dynamic spectrum utilization typically requires capability of detecting free radio resources and taking them into use efficiently so as to ensure efficient operation and/or reduced interference towards other systems, for example.

At present, communication devices may utilize aggregated frequencies such as primary frequency spectrum as well as a secondary frequency spectrum for capacity, bandwidth and throughput. In some instances, local conditions of a secondary cell associated with the secondary frequency spectrum may suggest that the secondary frequency spectrum should no longer be utilized and that the secondary cell should be deactivated.

Currently, a network entity typically initiates the decision to deactivate a secondary cell. However, in some cases, the network entity may not have first hand knowledge about the local conditions of the secondary cell. In this regard, the network entity may not always be capable of making the best or most reliable determination as to whether to initiate deactivation of a secondary cell.

### BRIEF SUMMARY

A method, apparatus, and computer program product are therefore provided for enabling a mobile device to efficiently and reliably, for example, determine whether to initiate deactivation of a secondary cell. In response to facilitating deactivation of the secondary cell, Carrier Aggregated frequency associated with the secondary cell may no longer be utilized by the mobile device. In this regard, one or more non-cellular frequencies (e.g., a white space frequency, an unlicensed frequency, etc.) provided by the secondary cell may be released such that the mobile device (e.g., user equipment (UE)) does not currently use the non-cellular frequencies or does not use the non-cellular frequencies until some time in the future.

As such, an example embodiment of the invention may enable a mobile device to initiate deactivation of one or more secondary cells utilizing Carrier Aggregation. In an example embodiment, Carrier Aggregation may, but need not, be associated with aggregated frequencies in white space frequency spectrum, unlicensed frequency spectrum, cellular frequency spectrum and any other suitable frequency spectrum. The triggering of the determination, by the mobile device, as to whether the secondary cell(s) should be deactivated may be based in part on one or more measurements associated with the secondary cell which may indicate a disturbance or interference within the secondary cell. The measurements may be performed by the mobile device.

Additionally or alternatively, the triggering of the determination, by the mobile device, as to whether the secondary cell(s) should be deactivated may be based in part on information received from one or more devices (e.g., white space databases, co-existence managers, etc.). The information received from one or more devices may specify instances or times that the mobile device may utilize the frequency spectrum of the secondary cell. In addition, the information received from the devices may include data specifying that the mobile device is prohibited from using the frequency spectrum of the secondary cell(s) due to a right of priority to utilize the frequency spectrum of the secondary cell(s) by one or more primary users (e.g., a TV broadcaster, a wireless microphone(s), etc.).

Based on receipt of information from one of the devices indicating that frequency spectrum is being allocated for usage to a primary user, the mobile device may initiate a determination that the secondary cell should be deactivated. In this regard, the mobile device may generate a message (e.g., a deactivation message) that may be sent to a network device (e.g., a base station (e.g., an e-Node B (eNB)) suggesting or instructing the network device to deactivate the secondary cell.

In one example embodiment, a method for generating a determination to deactivate a secondary cell is provided. The method may include determining that at least one secondary cell is to be deactivated based at least in part on a measurement(s) of the secondary cell or receipt of information associated with a frequency spectrum of the secondary cell. The method may further include generating a deactivation message in response to the measurement indicating an interference with the secondary cell or the received information indicating that the frequency spectrum should no longer be used by a first device. The method may further include enabling provision of the deactivation message to a network device.

In another example embodiment, an apparatus for generating a determination to deactivate a secondary cell is provided. The apparatus may include a processor and a memory including computer program code. The memory and the computer program code are configured to, with the processor, cause the apparatus to determine that at least one secondary cell is to be deactivated based at least in part on a measurement(s) of the secondary cell or receipt of information associated with a frequency spectrum of the secondary cell. The memory and computer program code may further cause the apparatus to generate a deactivation message in response to the measurement indicating an interference with the secondary cell or the received information indicating that the frequency spectrum should no longer be used by the apparatus. The memory and computer program code may further cause the apparatus to enable provision of the deactivation message to a network device.

In another example embodiment, an apparatus for generating a determination to deactivate a secondary cell is provided. The apparatus may include a processor and a memory including computer program code. The memory and the computer program code are configured to, with the processor, cause the apparatus to receive a deactivation message from a device. The deactivation message is generated in response to at least one measurement indicating an interference with a secondary cell or receipt of information indicating that a frequency spectrum of the secondary cell should no longer be used by the device. The memory and computer program code may further cause the apparatus to determine whether to deactivate the secondary cell based in part on the received deactivation message.

In another example embodiment, a computer program product for generating a determination to deactivate a secondary cell is provided. The computer program product includes at least one computer-readable storage medium having computer executable program code instructions stored therein. The computer executable program code instructions may include program code instructions configured to determine that at least one secondary cell is to be deactivated based at least in part on a measurement(s) of the secondary cell or receipt of information associated with a frequency spectrum of the secondary cell. The program code instructions may also be configured to generate a deactivation message in response to the measurement indicating an interference with the secondary cell or the received information indicating that the frequency spectrum should no longer be used by a first device. The program code instructions may also be configured to enable provision of the deactivation message to a network device.

In another example embodiment, an apparatus for generating a determination to deactivate a secondary cell is provided. The apparatus may include means for determining that at least one secondary cell is to be deactivated based at least in part on a measurement(s) of the secondary cell or receipt of information associated with a frequency spectrum of the secondary cell. The apparatus may also include means for generating a deactivation message in response to the measurement indicating an interference with the secondary cell or the received information indicating that the frequency spectrum should no longer be used by the apparatus. The apparatus may also include means for enabling provision of the deactivation message to a network device.

In another example embodiment, a computer program product for generating a determination to deactivate a secondary cell is provided. The computer program product includes at least one computer-readable storage medium having computer executable program code instructions stored therein. The computer executable program code instructions may include program code instructions configured to facilitate receipt of a deactivation message from a device. The deactivation message is generated in response to at least one measurement indicating an interference with a secondary cell or receipt of information indicating that a frequency spectrum of the secondary cell should no longer be used by the device. The program code instructions may also be configured to determine whether to deactivate the secondary cell based in part on the received deactivation message.

In another example embodiment, an apparatus for generating a determination to deactivate a secondary cell is provided. The apparatus may include means for receiving a deactivation message from a device. The deactivation message is generated in response to at least one measurement indicating an interference with a secondary cell or receipt of information indicating that a frequency spectrum of the secondary cell should no longer be used by the device. The apparatus may also include means for determining whether to deactivate the secondary cell based in part on the received deactivation message.

In another example embodiment, a method for generating a determination to deactivate a secondary cell is provided. The method may include receiving a deactivation message from a device. The deactivation message is generated in response to at least one measurement indicating an interference with a secondary cell or receipt of information indicating that a frequency spectrum of the secondary cell should no longer be used by the device. The method may also be configured to determine whether to deactivate the secondary cell based in part on the received deactivation message.

An embodiment of the invention may provide a more efficient manner in which to deactivate a secondary cell in an instance in which a communication device may be utilizing Carrier Aggregation. As such, a communications network may operate more efficiently. Additionally, communication devices utilizing the communications network may operate more efficiently and reliably resulting in a better user experience.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1A illustrates communication between a terminal device and a cellular communication system;

FIG. 1B illustrates an example of irregular utilization of frequency resources on an unlicensed spectrum;

FIG. 2 illustrates a flow diagram of a process for initiating frequency aggregation according to an example embodiment of the invention;

FIG. 3 illustrates a signaling diagram of initiating and configuring the frequency aggregation according to an example embodiment of the invention;

FIG. 4 illustrates operation in a terminal device for autonomously deciding to propose frequency aggregation according to an example embodiment of the invention;

FIG. 5 illustrates operation in a network element upon receiving a proposal for frequency aggregation according to an example embodiment of the invention;

FIG. 6 illustrates utilization of a secondary cell in connection with frequency aggregation according to an example embodiment of the invention;

FIGS. 7 and 8 illustrate block diagrams of apparatuses according to some example embodiments of the invention;

FIG. 9 illustrates a flow diagram for flow transfer upon establishing a secondary cell according to an example embodiment of the invention;

FIG. 10 is a schematic block diagram of a system according to an example embodiment of the invention;

FIG. 11 is a schematic block diagram of an apparatus for initiating a determination regarding whether a secondary cell should be deactivated according to an example embodiment of the invention;

FIG. 12 is a diagram illustrating frequency spectrum allocations that may be aggregated according to an example embodiment of the invention;

FIG. 13 is a schematic block diagram of a network entity according to an example embodiment of the invention;

FIG. 14 is a schematic block diagram of a system according to an example embodiment of the invention;

FIG. 15 is a signal flow diagram for generating a determination to deactivate a secondary cell according to an example embodiment of the invention; and

FIG. 16 illustrates a flowchart for generating a determination to deactivate a secondary cell according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

The following described embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

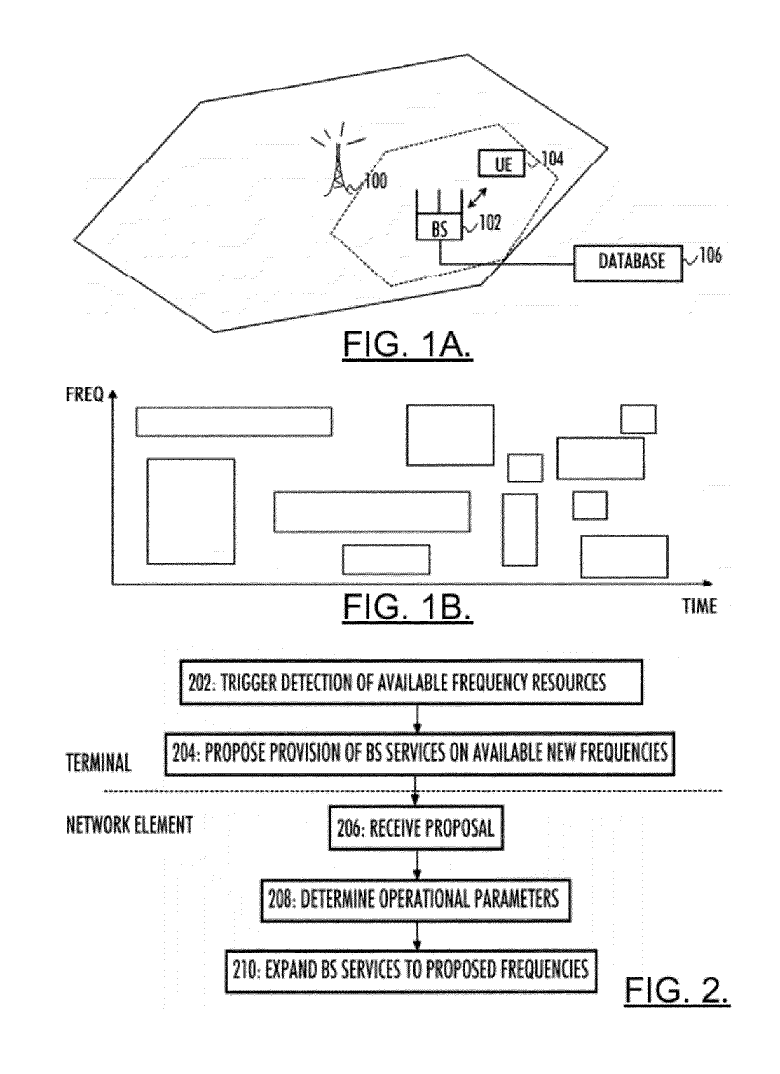

A general communication scenario to which embodiments of the present invention may be applied is illustrated in FIG. 1A. Referring to FIG. 1A, at least two systems are located such that their coverage areas overlap at least partly and that they may be configured to operate on a common frequency band. For example, a first system may be a television (TV) broadcast system comprising a broadcast tower 100 broadcasting television channels on some channels of the common frequency band. The first system may, however, be any other radio system. A second system may be, for example, a cellular system comprising a network element 102 as an access point or a base station (BS, also called Node B or evolved node B, eNB) providing a client station (also called a terminal device or user equipment, UE) 104 with bidirectional wireless communication services. The cellular system may also utilize frequency channels on the common frequency band.

For example, the Federal Communications Commission (FCC) in the United States has issued a report and order (R&O) which permits the use of TV white space (TV WS) spectrum. White space is the term used by the FCC for a TV spectrum which is not being occupied for primary usage e.g. by the TV or wireless microphone transmitters. The cellular system comprising the network element 102 may be configured to utilize available frequency bands of such a spectrum having a frequency band on a very high frequency band (VHF, 30 to 300 MHz), ultra-high frequency band (UHF, 300 to 3000 MHz), and/or other frequency bands. With respect to the second system, the cellular system may be based on the Universal Mobile Telecommunication System (UMTS) or any one of its evolution versions (e.g., long-term evolution, LTE, or LTE-Advanced), a system based on International Mobile Telecommunication (IMT) standard or any one of its evolution versions (e.g. IMT-Advanced), Worldwide Interoperability for Microwave Access (WiMAX), Institute of Electrical and Electronics Engineers (IEEE) 802.11-based network (e.g. IEEE 802.11n, 802.11af, or 802.11ac). However, the cellular system is not limited to these examples and it may be any other wireless network. The first (primary) system also need not be a TV broadcast or a wireless microphone transmitter system, and it may be any other system having a frequency band that may be shared with the cellular system and that may become fragmented through the frequency utilization of the first system. The frequencies may also be available without any assigned primary user, e.g. their utilization may be based on cognitive radio access schemes. In a broad sense, the first system may be any system operating on an unlicensed or license-exempt frequency band, e.g. the Industrial, Scientific, and Medical (ISM) band.

In some embodiments, the first system is a primary system having a priority over the frequency bands. The cellular system may then be configured to dynamically adapt to the spectrum utilization of the primary system and occupy a frequency band not used by the primary system in a given geographical area. In the following description, let us refer to the first system as the primary system and to the cellular system as the secondary system. In such embodiments, there may be rules for the secondary system to ensure minimization/lack of interference towards the primary system, and these rules may require access to information on free frequency bands in each geographical area and/or sensing and use of specified maximum transmit power levels. Such information on the free frequency bands may be stored in a database 106 to which the network element 102 and/or the client station 104 has access. The database 106 may store the maximum transmit power limits that the network element and/or client stations may not exceed so as not to interfere with the users of the primary system. The network element 102 and/or the client station 104 may obtain the information on the free frequency channels either directly or indirectly through any other node that has access to the database 106. For example, a client station may have a direct access to the database 106 to retrieve the current channel allocation in the area of the client station, or it may request a serving base station or another network element to retrieve the contents of the database 106. The serving base station or the other network element may retrieve the contents of the database 106 through a mobility management entity (MME) of the cellular system, for example.

An operator of the primary system or an authority like a regulator may update the database 106 as the channel allocation of the primary system changes, and the network element 102 and/or the client station may periodically (or constantly or upon notification of a change in the contents of the database) monitor the database 106 for an updated channel allocation and take measures to adjust its own frequency allocation accordingly.

In addition to the information about the primary system, the database may include identifications and rules for coexistence among the possible secondary systems operating in the spectrum of a primary system. Secondary use may be based on carrier sensing, listen-before-talk, competition, random access or any other such coexistence techniques.

As shown in FIG. 1B, spectrum utilization of the white spaces or unlicensed bands, e.g., the ISM band, may be fragmented in both time and frequency. The irregular spectrum occupation is illustrated by the boxes in FIG. 1B. The primary system may occupy different frequencies based on time and location, while numerous wireless communication systems may occupy and release arbitrary frequencies on the unlicensed bands. These spectral spaces may hence lack a clear raster of center frequencies and bandwidths. Therefore, available frequencies may be scanned in various manners before taking them into use. FIG. 2 illustrates a general concept according to some embodiments of the invention, and further embodiments are described in greater detail thereafter. FIG. 2 illustrates a flow diagram of processes for aggregating frequencies outside the frequencies dedicated, e.g. licensed, to the cellular communication system to the cellular frequencies. FIG. 2 illustrates a process carried out in a terminal device, and a process carried out in a serving base station or another network element of a cellular network.

Referring to FIG. 2, the terminal device is caused to initiate detection of available frequency resources outside dedicated frequency resources of the cellular communication system in block 202. This detection may be autonomous by the UE or may be initiated by the UE after assistance received from a network node, say a server. Some embodiments of events triggering the detection are described below. The detection may comprise scanning the frequency components, as described below, or determining their availability from the database 106 or from information received from locally authorized nodes, e.g. a coexistence manager used in IEEE 802.19 networks. In response to detection of available frequency resources as a result of the scanning, the terminal device may be caused to transmit to the serving base station in block 204 a message proposing provision of aggregation of at least some of scanned frequency resources detected to be available to the cellular frequencies.

In block 206, the network element of a network infrastructure receives from the terminal device, through a serving base station, the autonomously transmitted message proposing provision of aggregation of at least some of frequency resources outside dedicated frequency resources of the cellular communication system. In block 208, the network element may determine operational parameters of the aggregation on the basis of the received message. In block 210, the network element may configure aggregation of at least some of the proposed frequency resources with the determined operational parameters. The aggregation may be referred to as a carrier aggregation, wherein the network element configures establishment of new carriers on the frequencies outside the cellular frequencies. Carrier aggregation may be understood as aggregating white spaces, unlicensed frequencies or other free frequency resources to the frequencies on licensed bands of the cellular system. The carrier aggregation may be carried out in a base station, or generally the carrier aggregation may be realized by combined operation of a plurality of remote radio heads of a base station or non co-located base stations. Accordingly, the establishment of new carriers may be realized in the serving base station, in a remote radio head of the serving base station, or in another base station, e.g., a femtocell base station. The base stations realizing the aggregation may have different cell size hierarchies or even different access technologies. Aggregation may further mean aggregation of connections or network (e.g., Internet Protocol, IP, interfaces) for the traffic flows of a terminal device.

The remote radio head is by definition a spatially remote circuitry of the base station extending the coverage area of the base station, e.g., in tunnels and rural areas. The remote radio head may be a logic entity of the base station similar to radio components located at the base station site, and the remote radio head may comprise a radio frequency circuitry of the base station and, additionally analog-to-digital and digital-to-analog converter to convert signals transferred in a digital form between the remote radio head and the base station. The femtocell is a common term used in the modern communication systems to describe a small cellular base station typically designed for use in a home or small business, for example. The femtocell base station may be configured by the network element of the cellular network.

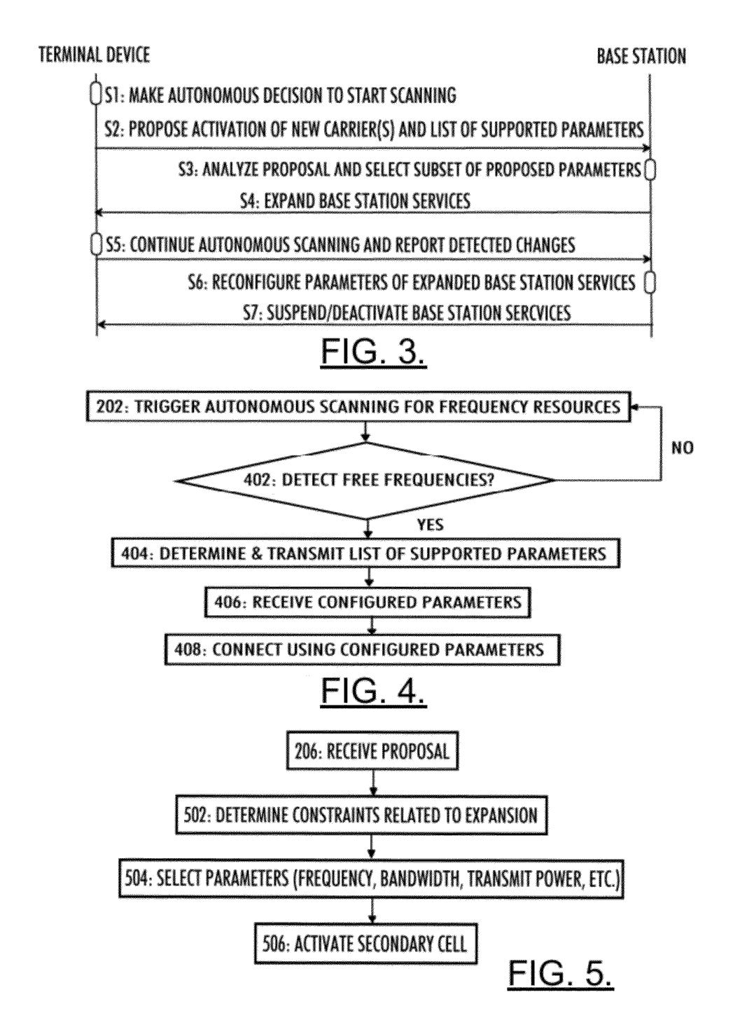

With reference to a signaling diagram of FIG. 3, let us describe the initialization of the aggregation according to an example embodiment is provided. In S1, the terminal device may make the decision to start scanning for available frequencies outside the cellular frequencies. The decision may be made autonomously and in response to at least one of the following: detecting a need for additional data transfer capacity, degradation of link quality of at least one existing link with the cellular network, time, and/or location of the terminal device. Examples of the need for the additional data transfer capacity comprise establishment of a new data flow, e.g., a new connection to the Internet, or increased data transfer requirements of an existing data flow. Parameter “time” refers to that the triggering event for the scanning is the time, e.g., the scanning is carried out during the office hours, or another period(s) of time. The location as the triggering event may refer to the availability of location-based services, for which the scanning is triggered. In other example embodiments, the location may trigger the scanning regardless of whether or not such location-based services are available. The database 106 may, for example, define locations where the white space frequencies are available, and arriving at such a location may trigger the scanning In other example embodiments, history data may be used as the triggering event. For example, prior timings and/or locations when the utilization of the frequencies outside the cellular frequencies has been successful may be as an input in S1. For example, such a timing and/or arriving at the same location/area may trigger the scanning In general, the terminal device may be configured to make the decision of when, where, and how to carry out the scanning without reception of a specific command from the network infrastructure.

The actual scanning may comprise detection of free frequencies (or channels) by estimating presence of an arbitrary radio signal on the frequencies. In such embodiments, the terminal device may blindly attempt to detect of presence of radio energy on the frequencies and omit attempting to derive any information from the contents or signal structure of the (possible) radio signals. Such embodiments may comprise determining a radio signal power or energy on a given frequency band. The determined metric proportional to the power or energy may then also be considered as a measure of interference, and upon determining that the interference level or spectral density of the interference is higher than a determined threshold, the frequency band may be determined to be unavailable. On the other hand, upon determining that the interference level is lower than the threshold, the frequency band may be determined to be available. In other embodiments, the scanning comprises detecting beacon signals or other known signals having a structure and/or contents that the terminal device is capable of analyzing. Such signals may be used for detecting whether or not it is possible to coexist with a system transmitting such signals by using at least partially overlapping resources. An access network discovery and selection function (ANDSF) of the cellular network may be used as assistance when discovering other access networks, e.g., the IEEE 802.11 or WiMAX networks. The terminal device may be configured to carry out the scanning by using multiple variable carrier frequencies and multiple variable bandwidths in the scanning to improve the scanning and the probability of success of the scanning. The terminal device may also use history data to obtain initial parameters for the scanning, e.g., first scan for those frequencies and bandwidths that have previously provided a successful aggregation, provided that they are allowed by the database 106 (if applicable). The history data may be analyzed by using state-of-the-art machine learning algorithms, for example. The terminal device may restrict the scanning to cover only those frequencies that are supported by the terminal device, and those frequencies on which the terminal device cannot communicate because of implementational reasons, for example, may be excluded from the scanning. It should be noted that the scanning may comprise operations that are different from those used in the cellular network, as mentioned above, e.g., the detection of presence of radio energy. These detection operations may apply any mathematical sampling, filtering, averaging, windowing or weighting functions to create the actual measurement result.

Upon detection of a set of available frequencies, each identified by the explicit frequency, a channel index, and/or any other channel identifier, the terminal device constructs the message proposing the aggregation, wherein the message comprises a list of detected frequencies that are proposed candidates for the aggregation. The message may comprise other parameters proposed by the terminal device in additional to the frequency indices, e.g., bandwidth and quality-of-service related parameters, parameters acquired as a result of scanning such as operational parameters defined by existing system(s) on the scanned frequencies. The terminal device may be configured to filter the list of frequencies according to a determined criterion, e.g., prefer free frequencies over occupied frequencies even though coexistence with another system was possible, to remove from the list frequencies previously discovered as problematic on the basis of history data, for example, and/or filtering rules derived from the database 106. The filtering may also take into account Quality-of-Service (QoS) requirements of a data flow for which the terminal device intends to propose the aggregation. In such a case, frequencies providing a continuous bandwidth satisfying the QoS requirements may be selected over frequencies providing a fragmented spectrum, and bandwidth smaller than the minimum bandwidth of the QoS requirements may be discarded. In a situation where QoS requirements are not given or are not clear or strict, the target of the aggregation may be to maximize the available bandwidth, minimize the consumed transmission power, or to minimize experienced or generated interference.

Then, the terminal device may transmit in S2 the proposal message to the serving base station which may be the network element processing the proposal and making the decision on whether or not to carry out the frequency aggregation. It should be noted that the network element may be another element of the network infrastructure as well. If the list is filtered by discarding at least some of the parameters, the terminal device may include in the message an information element indicating that in case the network element finds no suitable parameters for the aggregation from the proposed list, the terminal device is prepared to transmit another list with further parameters for proposal. The other list may then comprise at least some of the parameters discarded in the filtering procedure. The message transmitted by the terminal device may be a Radio Resource Control message or a higher layer message.

Upon reception of the list of supported parameters in S2, the base station analyzes the proposal and determines whether or not the list contains a subset of parameters that may be configured for the aggregation. The base station may store a database defining allowed frequencies and frequency aggregation options, e.g., list of frequencies that may be aggregated to the cellular frequencies, and the frequency (or frequencies) for the aggregation may be selected as allowed by such restrictions. Furthermore, the base station may compare bandwidth requirement for the aggregation with the set of proposed frequencies, and select the frequencies such that the number of separate (disjoint) frequency proportions or frequency bands required is minimized, and the number of adjacent (contiguous) frequencies in use are maximized. The base station may also make a decision as to whether to realize the aggregation in the base station site, in a remote radio head, or in a femto base station. The femtocell base station may be under the control of the aggregating base station. For such a purpose, the base station may determine the location of the terminal device in the cell of the base station. The location may be determined on the basis of path loss estimations and/or timing advance of the terminal device. The timing advance is a parameter proportional to the distance between the terminal device and the base station. Additionally, beamforming and other spatial estimation algorithms may be used to determine the distance and the direction of the terminal device with respect to the base station on the basis of angle of reception of a signal from the terminal device, for example. If the terminal device is in a coverage area of a femtocell base station or a remote radio head, the base station may select spatially distributed aggregation in which the remote radio head or the femtocell base station is configured to apply the aggregation. On the other hand, if the spatially distributed is not possible or feasible on the basis of the location of the terminal device or for other reasons, the base station may be configured to select co-located aggregation in which the base station expands the frequency range on the base station site to cover at least some of the proposed frequencies outside the cellular frequencies. The base station may use as an additional criterion for selecting the parameters to be applied similar proposals received from other terminal devices. For example, if a determined number (a plurality) of terminal devices proposes a given frequency band, the base station may prefer that frequency band over one proposed only by a single or few terminal devices. As a consequence, the base station may attempt to carry out the aggregation with parameters that meet the demands of as many terminal devices as possible. Another criterion may be the cost of additional frequencies. The aggregation may be applied to frequencies that are charged on the basis of their utilization, and the base station may be configured to prefer frequencies that are free of charge over frequencies that are charged.

As a consequence, the base station selects a subset or even a full set of proposed parameters and configures the aggregation in S3 and S4. In S4, the base station applies the aggregation or activates a remote radio head or a femtocell base station to apply the aggregation. The base station may also inform the terminal device about the aggregation and the selected parameters. Then, the new resources may be applied to the communication by expanding resources of active links to the new frequencies and/or by providing new radio bearer services, e.g. a new carrier, on the new frequencies. During the operation of the aggregation, the terminal device may continue carrying out the measurements autonomously in S5, report the measurement results to the network, and the base station may apply new frequencies and/or discard current frequencies and change other operational parameters on the basis of the measurement results in S6. This may include temporary suspension or deactivation of the aggregation and reestablishment with new parameter, or the changes may be applied on the fly during the operation. As a consequence, the system is able to adapt to a changing radio environment which may be abrupt on the non-licensed frequencies. When the additional frequencies utilized as a result of the aggregation are now longer needed or when the additional frequencies become unavailable, the base station suspends or deactivates the utilization of the additional frequencies in S7. This may include controlled release of the frequency resources which may include release of at least one radio link allocated to the additional frequency resources.

FIG. 4 illustrates a procedure of the terminal device for proposing the aggregation according to some embodiments of the invention. Referring to FIG. 4, the autonomous scanning of the frequency resources outside the cellular frequencies is triggered in 202. The triggering event may be any one of those listed above. The terminal device may select scanning parameters from the list of free white space frequencies derived from the database 106, for example. In one embodiment, the terminal device is configured to use a default bandwidth in the scanning, while in another embodiment, the terminal device applies a plurality of bandwidths for a given (or each) center frequency. As a consequence, the terminal device scans for the available frequencies by using a plurality of center frequencies and one bandwidth or a plurality of bandwidths for each center frequency. As mentioned above, the terminal device may determine a frequency to be free if no radio energy is detected on the frequency, the detected spectral density of received energy is below a tolerable threshold, and/or if the frequency is occupied by another system with which coexistence is possible. Such a system may be an IEEE 802.11 network, for example. In such a case, the terminal device may scan for a beacon frame broadcasted by the IEEE 802.11 network. In block 402, the terminal device determines whether or not a sufficient number of available frequencies have been detected. If it is determined as negative, the process returns to block 202 and the scanning is continued (optionally after a pause to reduce the power consumption). On the other hand, if the result in block 402 is affirmative, the process proceeds to block 404 in which the terminal device determines the parameters to be proposed for the aggregation and transmits list of proposed parameters to the base station. In block 406, the terminal device receives from the serving base station the parameters configured for the aggregation. In block 408, the terminal device applies the new frequencies. Block 408 may comprise negotiation of a new (secondary) radio bearer to realize the aggregation. The primary cellular connection may be maintained, as will be discussed below. The frequency aggregation may be applied to the existing radio connection, as mentioned above.

FIG. 5 illustrates the operation of the base station controlling the aggregation according to some embodiments of the invention. In block 206, the base station receives the proposal for the aggregation and the list of proposed parameters. In block 502, the base station determines constraints related to the aggregation. Some of the constraints related to the selection of the aggregation frequencies and bandwidths have been discussed above. Other restrictions may include transmission power. For example, the database 106 may set the restrictions to the transmit powers on the white space frequencies. In block 502, the base station may determine the frequencies the base station is able to aggregate to the current cellular frequencies such that the power constraints of the white space frequencies as set in the database are satisfied. This may rule out at least some of the proposed frequencies. The transmit power needed may be determined by estimating the channel between the base station and the terminal device, e.g., a path loss. In block 504, the base station selects the parameters for the aggregation (e.g. frequencies, bandwidth, co-located or spatially distributed aggregation, etc.). In block 506, the base station carries out the aggregation by activating a secondary cell with the selected frequencies and parameters that are a subset of those proposed by the terminal device. The secondary cell may be understood as the femtocell base station or another entity which forms a cell which is different from the cell of the serving base station. However, it may be understood as a creation of a new carrier in the serving base station, e.g., in a remote radio head. The serving base station may in some embodiments configure the operation and resource scheduling in the secondary cell, e.g., in the case of remote radio head. However, in other embodiments, the secondary cell is independent to carry out the resource scheduling autonomously, e.g., in a case where the secondary cell in coexistence with another system, e.g., an IEEE 802.11 (WiFi) network or IEEE 802.19 network. In such an example, the secondary cell may carry out the communication according to the specifications of the other system. For example, when the other system is the WiFi network, the communication in the secondary cell may be configured to comply with the channel contention and other communication rules of the IEEE 802.11 networks.

With respect to activating a secondary cell operating only on the unlicensed frequencies, while it can be construed that the secondary cell carries out no frequency aggregation, the frequency aggregation between the cellular and non-cellular frequencies is nevertheless affected on the system level and from the viewpoint of the terminal device.

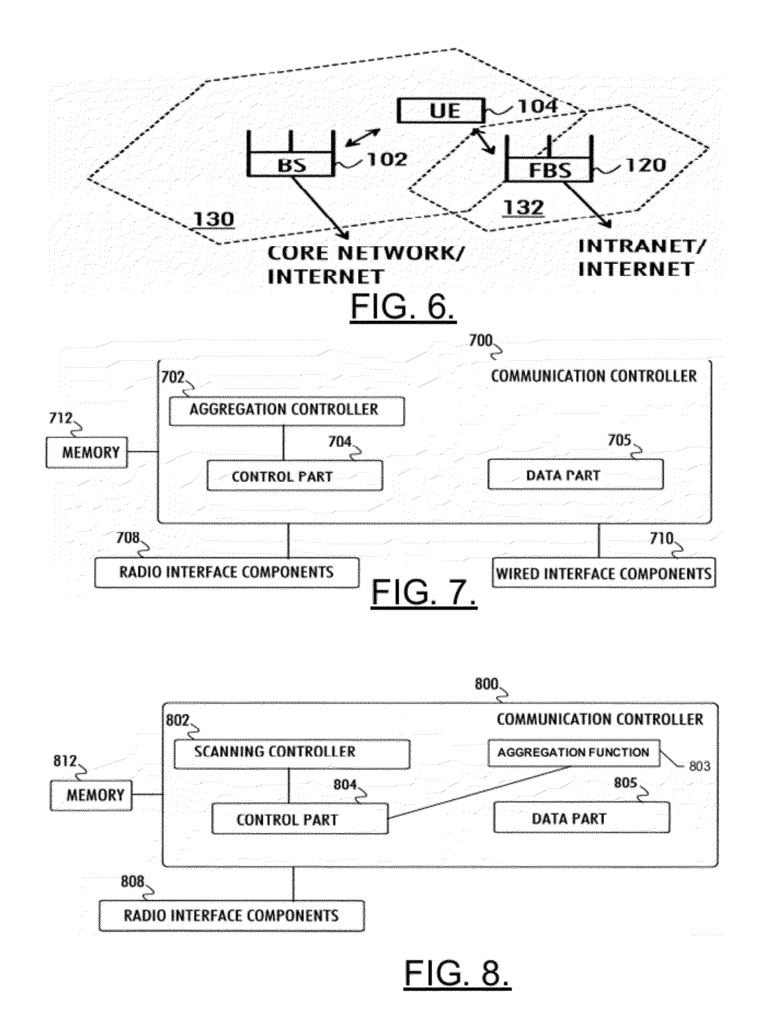

FIG. 6 illustrates an embodiment of utilization of the aggregation. The terminal device 104 may have the primary cellular connection with the serving base station 102 (associated with a primary cell 130) before and after the aggregation. In other words, the primary cellular connection may be maintained, and the aggregated extra frequencies may be used as supplementing the primary cellular connection. The primary cellular connection may provide the terminal device 104 with the connection to the Internet through a core network of the cellular communication system, for example. In case the secondary cell is utilized through a remote radio head or through a relay base station or a repeater, the aggregated extra frequencies also provide the connection through the core network. However, when the extra frequencies are delegated to another base station, e.g., a femtocell base station 120 (FBS in FIG. 6) or an IEEE 802.11 access point controlling a secondary cell 132, the extra frequencies may be used to provide the terminal device 104 with a second connection to the Internet through the femtocell base station or the IEEE 802.11 access point and through network other than the network of the cellular communication system. The femtocell base station may utilize, for example, a Digital Subscriber Line or Ethernet network for the wired connection to the intranet/Internet. These transport network links may also comprise wireless links, like microwave links or WiMax links, that could be used for transport.

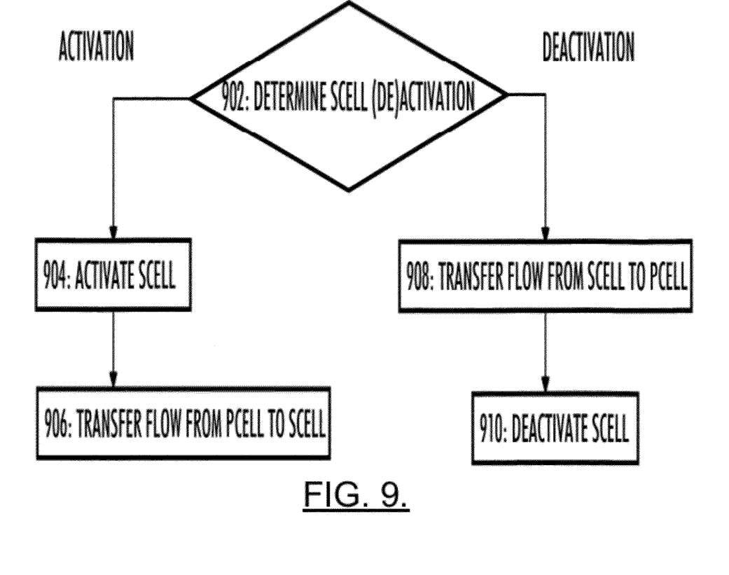

According to an embodiment, flow routing transfer between the primary cell (PCELL) connection and the secondary cell (SCELL) connection is carried upon activation and/or deactivation of the secondary cell and, optionally during the operation of the primary and secondary cell connections. The transfer of data flows between the two connections may also be called flow mobility. Furthermore, having the SCELL activated may impact the selection of the PCELL or the SCELL for the use of routing newly established flows. Similarly, deactivation of the SCELL may impact termination of a flow or parameterization of a flow respectively. Referring to FIG. 9, consider a process for flow mobility. The process may be carried out in the network element making the decision about the aggregation. Assume that initially a terminal device has a primary cell connection with the cellular network, wherein at least a first data flow is routed through the primary cell connection. In block 902, the network element makes a decision about activating or deactivating a secondary cell. When the decision in block 902 is the activation of the secondary cell, the network element configures the activation of the secondary cell in block 904 and allocates frequency band and other parameters for the secondary cell. From the viewpoint of the terminal device, block 904 comprises establishment of a secondary cell connection, and the terminal device now operates both the primary cell connection and the secondary cell connection similar to that illustrated in FIG. 6. Upon establishment of the secondary cell connection, the network element transfers at least some of the data of the first data flow to the secondary cell connection in block 906. Some of the data of the first data flow may still be routed through the primary cell connection. Additionally, a second data flow may be created for the secondary cell connection. The data flow in this context may refer to a higher layer data flow, e.g. a network layer or even a higher layer data flow. The data flow distributed to the primary and secondary cell connection may be aggregated on some layer (e.g., Internet protocol layer) in the cellular network and also in the terminal device.

Consider a situation where the secondary cell is activated, and the terminal device operates both the primary cell connection and the secondary cell connection. Upon deciding to deactivate the secondary cell in block 902, the network element may trigger the transfer of the data flows from the secondary cell connection to the primary cell connection 908. Block 908 may also comprise terminating at least one data flow. Upon completing the data flow transfer, the network element may configure the deactivation of the secondary cell in block 910 and release its frequency resources.

The flow transfer may be proposed by the terminal device in its proposal for carrying out the aggregation. The proposal message may comprise an information element which indicates whether the new frequency resources should be used for the provision of at least one new data flow or for additional capacity to at least one existing active data flow. However, the terminal device may make such a flow transfer proposal in connection with negotiating the secondary cell connection. The flow transfer may be triggered during the operation on the basis of qualities of the connections, e.g., more data may be routed to a connection having a better quality.

It should be noted that upon expanding the operation to the unlicensed frequencies and upon creating the SCELL connection for the terminal device, the PCELL connection may even be released or temporarily discontinued, while all the data routing is carried out over the SCELL connection. The discontinuation of PCELL connection may happen according to a negotiated discontinuity pattern, where the radio transmission is periodically OFF, while still maintaining the logical association between the terminal and the serving PCELL base station.

With respect to charging for the utilization of the extra frequencies additional to the cellular frequencies, an operator may add the additional costs incurred by the utilization of the secondary cell directly to the communication bills of the subscriber on the basis of the utilization of the extra frequencies. The costs may be tracked by a packet data network (PDN) gateway node of the UMTS LTE network (or a similar element in other systems) that tracks costs of traffic. The serving base station may acquire accurate statistics about the amount of traffic delivered via the primary cell connections and the secondary cell connections, and the duration a secondary cell connection on a given frequency band has been active for a given terminal device.

FIG. 7 illustrates an embodiment of an apparatus comprising means for carrying out the above-mentioned functionalities of the network element. The apparatus may be applicable to a cellular communication system described above and it may form part of a base station or another network element of such a system. In an embodiment, the apparatus is the base station. In another embodiment, the apparatus is comprised in such a network element, e.g., the apparatus may comprise a circuitry, e.g., a chip, a processor, a micro controller, or a combination of such circuitries in the network element and cause the network element to carry out the above-described functionalities.

The apparatus may comprise a communication controller circuitry 700 configured to control the communications in the apparatus. The communication controller circuitry 700 may comprise a control part 704 handling control plane signaling in a cell. For example, the control part may control establishment, operation, and termination of cellular connections with terminal devices and carry out radio resource control procedures in a cell. The communication controller circuitry 700 may further comprise a data part 705 that handles transmission and reception of payload data with the terminal devices. The data part 705 may forward data received from the terminal devices towards the core network and data received from the core network to the terminal devices.

The apparatus may further comprise a aggregation controller circuitry 702 configured to receive from at least one terminal device through the control part 704 a proposal for aggregation of frequencies outside the frequencies dedicated to the cellular system, e.g. the white space frequencies and/or the ISM band. The proposal may identify proposed frequencies and/or other operation parameters for the aggregation. The aggregation controller circuitry 702 may process the proposal by determining whether or not the proposal comprises a subset of parameters that are applicable to and compatible with current operational parameters in the cell and/or in the cellular system. The aggregation controller circuitry 702 may also determine how to implement the aggregation, e.g., whether to activate and configure a femtocell base station to the proposed frequencies or whether to establish at least one new carrier in a currently operational base station. If a subset of parameters is detected and the aggregation is found to be feasible, the aggregation controller circuitry 702 configures the aggregation of such unlicensed frequencies by configuring the control part to carry out the aggregation or to command a femtocell base station to execute the aggregation. During the operation of the aggregation, the aggregation controller circuitry 702 may control reconfiguration of the operational parameters for the aggregation and deactivation of the aggregation, as described above.

The circuitries 702 to 705 of the communication controller circuitry 700 may be carried out by the one or more physical circuitries or processors. In practice, the different circuitries may be realized by different computer program modules. Depending on the specifications and the design of the apparatus, the apparatus may comprise some of the circuitries 702 to 705 or all of them.

The apparatus may further comprise one or more memories 712 that stores computer programs (software) configuring the apparatus to perform the above-described functionalities of the communication device. The memory 712 may also store communication parameters and other information needed for the wireless communications and/or to carry out the aggregation. For example, the memory 712 may store a list of allowed frequencies on the unlicensed bands and/or a list of preferred frequencies or frequency band combinations for use by the aggregation controller circuitry 702. The apparatus may further comprise radio interface components 708 providing the apparatus with radio communication capabilities with the terminal devices and/or other network nodes, e.g., with femtocell base stations. The radio interface components 708 may comprise standard well-known components such as amplifier, filter, frequency-converter, (de)modulator, and encoder/decoder circuitries and one or more antennas. The apparatus may further comprise wired interface components 710 that may be configured to provide the apparatus with a wired connection to other elements of the cellular system, e.g., the core network. The wired interface components may realize an IP connection or an S1 connection used in the UMTS LTE networks, for example.

In an embodiment, the apparatus carrying out the embodiments of the invention for controlling the aggregation comprises at least one processor and at least one memory including a computer program code, wherein the at least one memory and the computer program code are configured, with the at least one processor, to cause the apparatus to carry out the steps of the network element in any one of the processes of FIGS. 2, 3, and 5. Accordingly, the at least one processor, the memory, and the computer program code form processing means for carrying out embodiments of the present invention in the network element.

FIG. 8 illustrates an embodiment of an apparatus comprising means for carrying out the above-mentioned functionalities of the terminal device. The apparatus may be a terminal device of a cellular communication system, e.g. a computer (PC), a laptop, a tabloid computer, a cellular phone, a communicator, a smart phone, a palm computer, or any other communication apparatus. In another embodiment, the apparatus is applicable to such a terminal device, e.g. the apparatus may comprise a circuitry, e.g. a chip, a processor, a micro controller, or a combination of such circuitries in the terminal device.

The apparatus may comprise a communication controller circuitry 800 configured to control the communications in the apparatus. The communication controller circuitry 800 may comprise a control part 804 handling control plane signaling with a serving base station and, optionally, with other base stations or communication devices including other terminal devices in direct device-to-device connections. For example, the control part 804 may control establishment, operation, and termination of cellular connections with the cellular network and carry out radio resource control procedures in the terminal device under the control of the cellular network. The communication controller circuitry 800 may further comprise a data part 805 that handles transmission and reception of payload data with the cellular network and/or with other base stations or terminal devices. The data part 805 may forward data received from an application executed in the terminal device towards the cellular network and data received from the cellular network to the application. The apparatus may further include an aggregation function 803 configured to operate on proposed frequencies and/or other operation parameters for the aggregation, defined for example by the aggregation controller of FIG. 7. The aggregation function may implement the aggregation, e.g., whether to activate or deactivate the frequencies or whether to transmit or receive data on a new carrier. In other words, the aggregation function 803 may execute the aggregation.

The apparatus may further comprise a scanning controller circuitry 802 configured to operate autonomously and independent of the cellular network when determining to trigger scanning of free frequencies outside the frequency band(s) of the cellular network. The scanning controller circuitry 802 may be configured to determine at least some of the scanned frequencies from information on free white space frequencies retrieved from the database 106, thereby limiting the frequency range to be scanned. The scanning controller circuitry 802 may limit the number of scanned frequencies and/or bandwidth by other means. The scanning controller circuitry 802 may carry out the scanning according to a determined scanning procedure in which the scanning controller circuitry 802 scans for presence of radio energy and/or attempts to detect a determined signal structure on scanned frequencies, as described above. Upon detecting available frequencies, the scanning controller circuitry 802 may be configured to construct a message for transmission to a serving base station, wherein the message comprises a list of available frequencies and, optionally, other parameters proposed for the aggregation. The message may be constructed upon determining to propose the aggregation so as to activate the aggregation or after the aggregation has been carried out so as to reconfigure the operational parameters of the aggregation. The message may also be formulated to propose deactivation of the aggregation. The scanning controller circuitry 802 may command the control part 804 to carry out the transmission of the message to the serving base station. The control part 804 may be configured to receive from the network information on the aggregation of the unlicensed frequencies, and to control the terminal device to apply the aggregation by configuring establishment of a new radio bearer or by other means under the control of the cellular network.

The circuitries 802 to 805 of the communication controller circuitry 800 may be carried out by the one or more physical circuitries or processors. In practice, the different circuitries may be realized by different computer program modules. Depending on the specifications and the design of the apparatus, the apparatus may comprise some of the circuitries 802 to 805 or all of them.

The apparatus may further comprise one or more memories 812 that stores computer programs (e.g., software) configuring the apparatus to perform the above-described functionalities of the communication device. The memory 812 may also store communication parameters and other information needed for the wireless communications and/or to carry out the scanning. For example, the memory 812 may store a list of allowed frequencies on the unlicensed bands and/or a list of preferred frequencies or frequency band combinations for use by the scanning controller circuitry 802. The apparatus may further comprise radio interface components 808 providing the apparatus with radio communication capabilities with the cellular network and/or other base stations, e.g., with femtocell base stations, and/or with other terminal devices over direct device-to-device radio links. The radio interface components 808 may comprise standard well-known components such as amplifier, filter, frequency-converter, (de)modulator, and encoder/decoder circuitries and one or more antennas. The apparatus may further comprise a user interface enabling interaction with the user of the communication device. The user interface may comprise a display, a keypad or a keyboard, a loudspeaker, etc.

In an embodiment, the apparatus carrying out the embodiments of the invention for proposing the aggregation comprises at least one processor and at least one memory including a computer program code, wherein the at least one memory and the computer program code are configured, with the at least one processor, to cause the apparatus to carry out the steps of the terminal device in any one of the processes of FIGS. 2, 3, and 4. Accordingly, the at least one processor, the memory, and the computer program code form processing means for carrying out embodiments of the present invention in the terminal device.

The processes or methods described in FIGS. 2 to 5 may also be carried out in the form of a computer process defined by a computer program. The computer program may be in source code form, object code form, or in some intermediate form, and it may be stored in some sort of carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

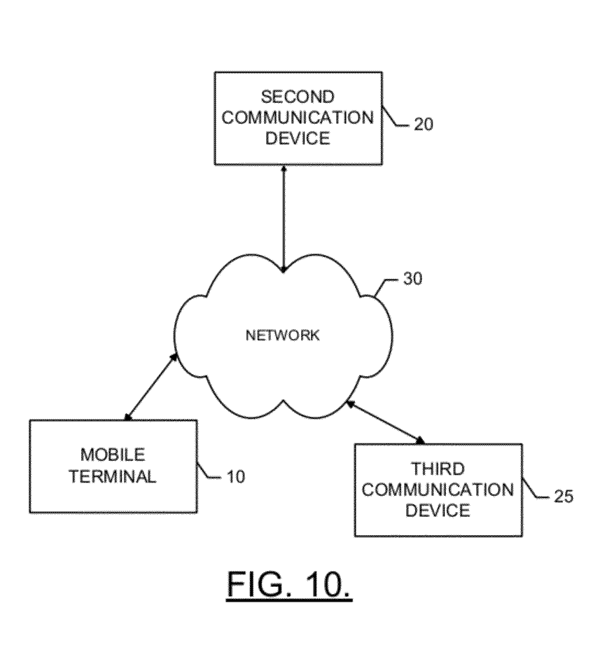

FIG. 10 illustrates a generic system diagram in which a device such as a mobile terminal 10 is shown in an exemplary communication environment. As shown in FIG. 10, an embodiment of a system in accordance with an example embodiment of the invention may include a first communication device (e.g., mobile terminal 10) and a second communication device 20 capable of communication with each other via a network 30. In some cases, an embodiment of the invention may further include one or more additional communication devices, one of which is depicted in FIG. 10 as a third communication device 25. In one embodiment, not all systems that employ an embodiment of the invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ an embodiment of the invention. Furthermore, devices which are not mobile, such as servers and personal computers may also readily employ an embodiment of the invention.

The network 30 may include a collection of various different nodes (of which the second and third communication devices 20 and 25 may be examples), devices or functions that may be in communication with each other via corresponding wired and/or wireless interfaces. As such, the illustration of FIG. 10 should be understood to be an example of a broad view of certain elements of the system and not an all inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like. In one embodiment, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 10, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (WiFi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as, for example, personal computers (PCs) or laptop computers.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

As such, in one embodiment, the mobile terminal 10 may itself perform an example embodiment. In another embodiment, the second and third communication devices 20 and 25 may facilitate operation of an example embodiment at another device (e.g., the mobile terminal 10). In still one other example embodiment, the second communication device 20 and the third communication device 25 may not be included at all.

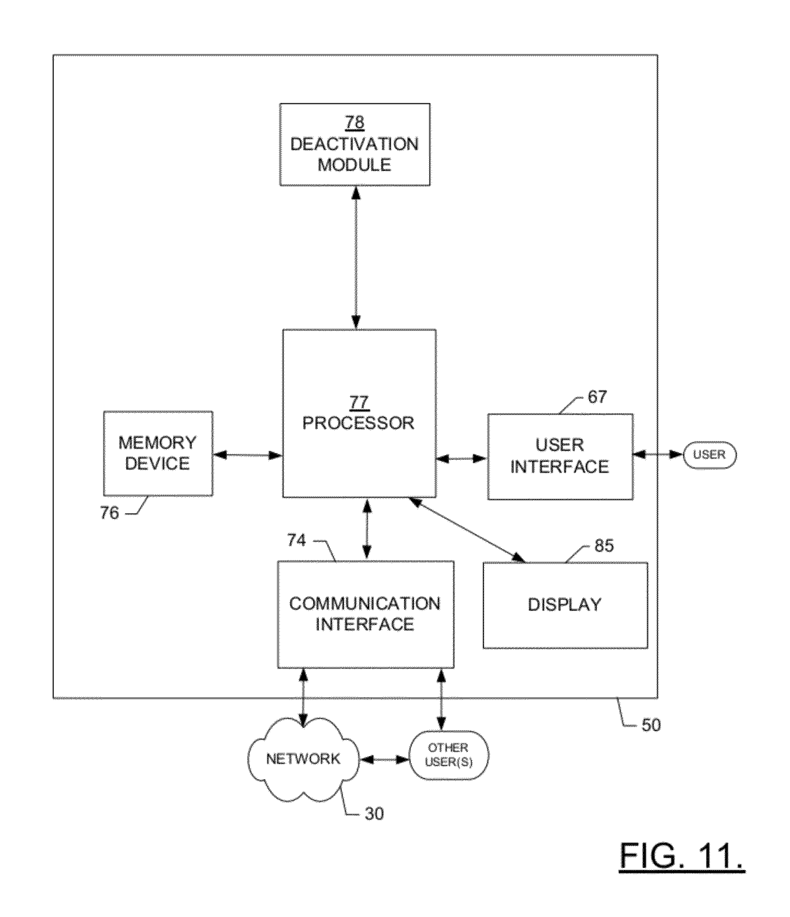

In another example embodiment, the mobile terminal as well as the second and third communication devices 20 and 25 may employ an apparatus (e.g., apparatus of FIG. 11) capable of employing some embodiments of the invention.

Referring now to FIG. 11, an apparatus that may benefit from embodiments of the invention is provided. The apparatus 50 (e.g., UE 104) may include or otherwise be in communication with a processor 77, a user interface 67, one or more speakers, a communication interface 74, a memory device 76 (also referred to herein as memory 76), and a display 85.

The memory device 76 may include, for example, volatile and/or non-volatile memory. The memory device 76 may be configured to store information, data, applications, instructions or the like for enabling the apparatus to carry out various functions in accordance with exemplary embodiments of the invention. The memory device 76 could be configured to buffer input data for processing by the processor 77. Additionally or alternatively, the memory device 76 could be configured to store instructions for execution by the processor 77. As yet another alternative, the memory device 76 may be, or may include, one of a plurality of databases that store information and/or media content.

The processor 77 may be embodied in a number of different ways. For example, the processor 77 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an example embodiment, the processor 77 may be configured to execute instructions as well as algorithms stored in the memory device 76 or otherwise accessible to the processor 77. As such, whether configured by hardware or software methods, or by a combination thereof, the processor 77 may represent an entity (e.g., physically embodied in circuitry) capable of performing operations according to an embodiment of the present invention while configured accordingly. Thus, for example, when the processor 77 is embodied as an ASIC, FPGA or the like, the processor 77 may be specifically configured hardware for conducting the operations described herein. Alternatively, as another example, when the processor 77 is embodied as an executor of software instructions, the instructions may specifically configure the processor 77, which may otherwise be general purpose processing elements or other functionally configurable circuitry if not for the specific configuration provided by the instructions, to perform the algorithms and operations described herein. However, in some cases, the processor 77 may be a processor of a specific device (e.g., a mobile terminal or user equipment (UE)) adapted for employing embodiments of the invention by further configuration of the processor 77 by instructions for performing the algorithms and operations described herein.

In an example embodiment, the processor 77 may be configured to operate a connectivity program, such as a conventional Web browser. The connectivity program may then enable the apparatus 50 to transmit and receive Web content, such as location-based content, according to a Wireless Application Protocol (WAP), for example. The processor 77 may also be in communication with the display 85 and may instruct the display to illustrate any suitable information, data, content or the like.

Meanwhile, the communication interface 74 may be any means such as a device or circuitry embodied in either hardware, software, or a combination of hardware and software that is configured to receive and/or transmit data from/to a network and/or any other device, module or other user(s) in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. The communication interface 74 may receive and/or transmit data via one or more communication channels. Additionally, in some embodiments the communication interface 74 may include a communication modem and/or hardware/software for supporting communication via cable, digital subscriber line (DSL), universal serial bus (USB), Ethernet or other mechanisms.

The user interface 67 may be in communication with the processor 77 to receive an indication of a user input at the user interface 67 and/or to provide an audible, visual, mechanical or other output to the user. As such, the user interface 67 may include, for example, a keyboard, a mouse, pointing device (e.g., stylus, pen, etc.) a joystick, a display, a touch screen, a microphone, a speaker, or other input/output mechanisms. In an exemplary embodiment in which the apparatus is embodied as a server or some other network devices, the user interface 67 may be limited, remotely located, or eliminated.

The processor 77 may comprise user interface circuitry configured to control at least some functions of one or more elements of the user interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

The processor 77 may be configured to enable the apparatus 50 (e.g., UE 104) to utilize Carrier Aggregated (CA) frequencies. The processor 77 may enable the apparatus 50 to utilize CA frequencies in response to receipt of an instruction from a network element (e.g., base station 102 (also referred to herein as network element 102), for example. In this regard, the processor 77 may establish a primary cell (e.g., primary cell 130) connection with a cellular network, in which data (e.g., first data (e.g., a first data flow)) may be routed through the primary cell connection, such that the apparatus 50 may utilize allocated frequency band and other resources of the primary cell.

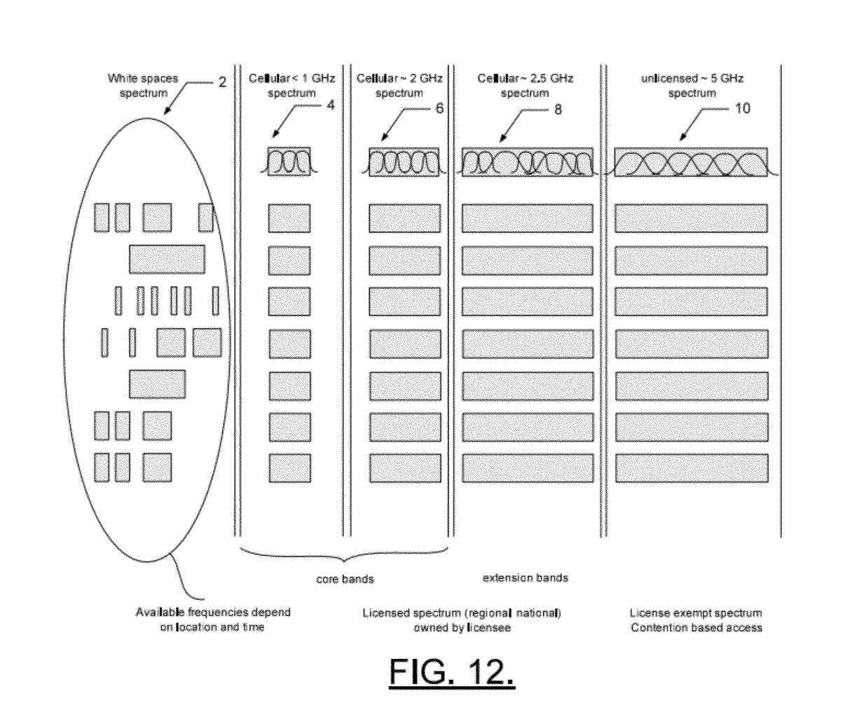

The frequency band of the primary cell may include, but is not limited to, one or more cellular frequencies (e.g., cellular frequencies 4, 6, 8 of FIG. 12) and any other suitable frequencies. Additionally, the processor 77 may establish connection with a secondary cell (e.g., secondary cell 132) in which the apparatus 50 may utilize allocated frequency band and other parameters of the secondary cell. The processor 77 may enable the apparatus 50 to establish connection with a secondary cell (e.g., secondary cell 132) via connection with a network device (e.g., base station 120, also referred to herein as network device 120) of the secondary cell. The frequency band of the secondary cell may include, but is not limited to, one or more white space frequencies (e.g., white space frequencies 2 of FIG. 12), one or more unlicensed frequencies (e.g., unlicensed frequencies 10 of FIG. 12), or the like and any other suitable frequencies. The apparatus 50 may operate on both the primary cell connection and the secondary cell connection. For instance, upon establishment of the connection with the secondary cell, the processor 77 may receive at least a portion of data (e.g., first data (e.g., first data flow) from the secondary cell (or base station 120). Additionally, some of the data (e.g., first data) may still be routed through the primary cell connection. Additionally or alternatively, other data (e.g., second data (e.g., a second data flow) may be provided by the secondary cell connection, via a network device (e.g., base station 120), to the apparatus 50. In this regard, the data distributed on the primary cell and secondary cell connection to the apparatus 50 may be aggregated by the processor 77.

In an example embodiment, the processor 77 may be embodied as, include or otherwise control a deactivation module 78. As such, in one embodiment, the processor 77 may be said to cause, direct or control the execution or occurrence of the various functions attributed to the deactivation module 78, as described herein. The deactivation module 78 may be any means such as a device or circuitry operating in accordance with software or otherwise embodied in hardware or a combination of hardware and software (e.g., processor 77) operating under software control, the processor 77 embodied as an ASIC or FGPA specifically configured to perform the operations described herein, or a combination thereof) thereby configuring the device or circuitry to perform the corresponding functions of the deactivation module, as described therein. Thus, in examples in which software is employed, a device or circuitry (e.g., the processor 77 in one example) executing the software forms the structure associated with such means.

In an example embodiment, the deactivation module 78 may be configured to originate or initiate a determination as to whether to deactivate a secondary cell and may release frequency resources (e.g., white space frequencies, unlicensed frequencies, etc.) of the secondary cell. The deactivation module 78 may determine whether a secondary cell is to be deactivated based in part on data associated with one or more interference measures (also referred to herein as interferers). In an example embodiment, the deactivation module 78 may provide the determination regarding whether to deactivate a secondary cell to a network device (e.g., base station 120) and when the determination indicates that the secondary cell should be deactivated, the network device may facilitate the deactivation of the apparatus 50 from the secondary cell. The deactivation module 78 may provide the determination as to whether to deactivate the apparatus 50 from the secondary cell since the apparatus 50 may have direct access to information associated with interferers that the network device may be unaware of or that the network device may not be able to access. In this regard, the deactivation module 78 may be better suited to make the determination as to whether the apparatus 50 should be deactivated from a secondary cell. The interference measures may relate to one or more measurements performed by the deactivation module 78 of the apparatus 50 and/or receipt of information by the deactivation module 78 from one or more other devices.

The interference measures that may, but need not, trigger the deactivation module 78 to determine that the secondary cell is to be deactivated, and that the frequency resources of the secondary cell should be released, may include but are not limited to: (1) a sensed primary user measurement; (2) a sensed disturbance measurement; (3) a low signal-to-interference noise ratio (SINR) measurement (e.g., a SINR below a predetermined threshold); (4) an estimation of an emergence of a primary user or other blocking activity (e.g., a disturbance) based on machine learning or other mechanisms (e.g., history information of the traffic and use of a channel(s) in a corresponding location(s); (5) other mechanisms of predicting future needs of a primary cell and/or secondary cell such as, for example, a detection that the apparatus is reaching a cell edge; (6) a low power measurement (e.g., a power measurement below a predetermined threshold); (7) one or more measures associated with quality of service (QoS) (e.g., bit rate, delay, jitter measures, etc.) requirements (e.g., measures of QoS requirements below a predetermined threshold); (8) presence information (e.g., information associated with time, location, environment (e.g., public, office, home, etc.) of use changes, etc.; (9) use case information (e.g., information associated with service type, flow type, application type changes, bandwidth use changes, etc.); (10) information received locally from other devices such as, for example, a TV band device (TVBD, e.g., a white space device); (10) information received locally or globally from one or more databases such as, for example, a white space (WS) database or devices such as, for example, co-existence managers; (11) a detection of information denoting that the apparatus 50 is moving out of a geographical area in which usage of secondary frequencies (e.g., white space frequencies, unlicensed frequencies, etc.) are known to be allowed; and (12) any other suitable measures or information, including, but not limited to, Block Error Rate (BER), throughput measures of an active link, etc. may be utilized by the deactivation module 78 to determine whether the secondary cell should be deactivated.

As an example of the sensed primary user measurement, consider an instance in which one or more users have priority rights to utilize the frequency spectrum of a secondary cell. In this regard, the deactivation module 78 may determine that there is at least one primary user (e.g., a TV broadcaster, a wireless microphone(s)) with a higher priority right to utilize the frequency spectrum of a secondary cell. For instance, in this example, the primary user with the higher priority rights may utilize the frequency spectrum as much as needed. In this regard, in an instance in which the deactivation module 78 determines that the primary user with the higher priority rights is utilizing the frequency spectrum of the secondary cell, the deactivation module 78 may determine that the apparatus 50 should deactivate its usage of the secondary cell. On the other hand, in an instance in which the deactivation module 78 may determine that the primary user is not utilizing the frequency spectrum of the secondary cell, the deactivation module 78 may determine that the apparatus may continue to utilize the frequency spectrum of the secondary cell.

As described above, the deactivation module 78 may utilize a sensed disturbance measurement to determine whether a secondary cell should be deactivated. As an example, the deactivation module 78 may determine whether another device is utilizing the frequency spectrum of the secondary cell. In an instance in which the deactivation module 78 determines that the other device is causing a level of disturbance, equaling or exceeding a predetermined threshold, for example, the deactivation module 78 may determine that the apparatus 50 should deactivate its usage of the secondary cell.

The deactivation module 78 may estimate the emergence of a primary user or other blocking activity based on machine learning mechanisms based in part on analyzing historical information. In this regard, the deactivation module 78 may utilize historical information to program software code, for example, to make predications about what is likely to happen in the future and may utilize learned behavior of a primary user (e.g., a TV broadcaster) of the frequency spectrum of a secondary cell to predict the behavior of the primary user. For purposes of illustration and not of limitation, consider an instance in which the deactivation module 78 may determine that during a particular time interval (e.g., 6:00 AM to 12:00 PM (noon) that there is frequency spectrum (e.g., white space frequency) available in the secondary cell that is generally unused. In this regard, the deactivation module 78 may determine that apparatus 50 should be able to utilize the frequency spectrum during the time interval (e.g., 6:00 AM to 12:00 PM). On the other hand, in an instance in which the deactivation module 78 may determine based on historical data that a primary user typically utilizes the frequency spectrum of a secondary cell during a certain time period (e.g., 6:00 PM to 12:00 AM (midnight)), the deactivation module 78 may determine that the apparatus 50 should be deactivated from the secondary cell.

Additionally, as described above, the deactivation module 78 may utilize presence information associated with time, location, environment of use and any other suitable use information to determine whether the apparatus 50 should be deactivated from a secondary cell. In this regard, the deactivation module 78 may utilize learned behavior associated with the usage of the apparatus 50 during certain times, locations and environments to determine whether the apparatus 50 should be deactivated from a secondary cell. For instance, the deactivation module 78 may have learned that when the apparatus 50 is in a particular location and/or an environment such as, for example, an airport within a particular city or a car within a particular area of a city that the apparatus 50 should be deactivated from the secondary cell. In this regard, for example, the deactivation module 78 may have learned, based in part on historical data, that the apparatus 50 does not receive good reception in the airport and/or the car. As such, in an instance in which the deactivation module 78 may determine that the apparatus 50 is in the particular location(s) and/or environment(s), the deactivation module 78 may determine that the apparatus 50 should be deactivated from the secondary cell.

The deactivation module 78 may utilize other mechanisms to predict whether to deactivate the apparatus 50 from the secondary cell. For example, in an instance in which the deactivation module 78 may determine based on historical data that reception at the edge of the secondary cell is poor during a certain time period (e.g., 12:00 PM to 5:00 PM), the deactivation module 78 may determine that the apparatus 50 should be deactivated from the secondary cell during the time period.

The interference measures (also referred to herein as WS measurements) obtained by the deactivation module 78, for example, may be appended, by the deactivation module 78, to a report such as, for example, a WS measurement container (also referred to herein as WS_meas) report. In addition to data associated with the interference measures, the WS_meas report may also include cellular measurements. The WS_meas report may be provided by the deactivation module 78 to a network device in order to enable the network device to determine whether the apparatus 50 should be deactivated from a corresponding secondary cell. Alternatively, the interference measures may be signaled to the network device independently from cellular measurements.

The WS measurements obtained by the deactivation module 78 may be specific in that the deactivation module 78 may be unable to rely on the presence of the reference sequences and pilot symbols in a format (e.g., time, frequency, space positions of the symbols and their modulated sequence type) provided by a mobile telecommunications system standard (e.g., Long Term Evolution Advanced (LTE-A) standard). On the contrary, frequency spectrum (e.g., white space frequency) of a secondary cell may be occupied by an interferer(s). In this regard, the deactivation module 78 may sense the frequency spectrum being used and may detect primary user disturbance/interference or any other suitable disturbance. As such, the deactivation module 78 may need to be able to detect interference or disturbance in order to determine whether the apparatus 50 should be deactivated from a secondary cell.

In one example embodiment, in an instance in which the deactivation module 78 may determine that the apparatus 50 should be deactivated from a secondary cell and released from utilizing the frequency spectrum of the secondary cell, the deactivation module 78 may, but need not, send a message (e.g., deactivation message) to a network device (e.g., base station 120) requesting or suggesting deactivation of the apparatus 50 from the secondary cell. However, the apparatus 50 may continue to utilize the frequency spectrum of the secondary cell until the network device facilitates the deactivation of the apparatus 50 from the secondary cell.

In another example embodiment, in an instance in which the deactivation module 78 may determine that the apparatus 50 should be deactivated from a secondary cell and released from utilizing the frequency spectrum of the secondary cell, the deactivation module 78 may, but need not, automatically stop utilizing the secondary cell. In this example embodiment, the deactivation module 78 may also send a message to a network device (e.g., base station 120) requesting or suggesting to the network device that the apparatus 50 should be deactivated from the secondary cell. In this regard, the network device may, but need not, determine that it should not schedule any additional future resources to the secondary cell, for example in an instance in which the deactivation module 78 determines that the reception of the secondary cell is always poor.

Referring now to FIG. 12, a diagram illustrating frequency spectrum that may be aggregated and utilized by an apparatus according to an example embodiment is provided. In the example of FIG. 12, an apparatus (e.g., apparatus 50 (e.g., UE 104)) may perform Carrier Aggregation on the white space frequency spectrum 2, the cellular frequency spectrum 4, the cellular frequency spectrum 6, the cellular frequency spectrum 8 and the unlicensed frequency spectrum 10. In an example embodiment, the cellular frequency 4, the cellular frequency 6 and the cellular frequency 8 may, but need not, be provided by a primary cell (e.g., primary cell 130). Additionally, the white space frequency spectrum 2 and/or the unlicensed frequency spectrum 10 may be provided by a secondary cell (e.g., secondary cell 132).

The availability of the white space frequency spectrum 2 may depend on location and/or time, for example. For instance, even in the case of Carrier Aggregation for a secondary cell in cellular bands, the mobility of an apparatus (e.g., apparatus 50) may be an issue, which may cause activation/deactivation of a secondary cell and which may have an impact on apparatus requested measurements for the Carrier Aggregation. However, the mobility of an apparatus may present different issues for operation of white space frequency spectrum because for white space frequency spectrum (e.g., white space frequency spectrum 2) the availability of the white space frequency spectrum proportions may be dependent on the location of the apparatus, time of the day and on the use (e.g., primary use) of the white space frequency spectrum. As such, the availability of the white space frequency spectrum 2 for Carrier Aggregation may be more local and temporal by nature as compared to Carrier Aggregation of a secondary cell that may be configured for usage in cellular bands, which may be licensed and reserved for a cellular communications operator. In this regard, the availability and dynamism of the non-cellular frequency spectrum may depend on the nature of the spectrum and on the location, such as, for example a city and wireless microphones versus rural areas and TV stations as examples.

In the example of FIG. 12, the cellular frequency spectrum 4 and the cellular frequency 6 may relate to cellular core bands and the cellular frequency spectrum 8 may relate to a cellular extension band. The cellular frequency spectrum 4, the cellular frequency 6 and the cellular frequency 8 may relate to licensed frequency spectrum for cellular frequency bands. The unlicensed frequency spectrum 10 may relate to license-exempt frequency bands.

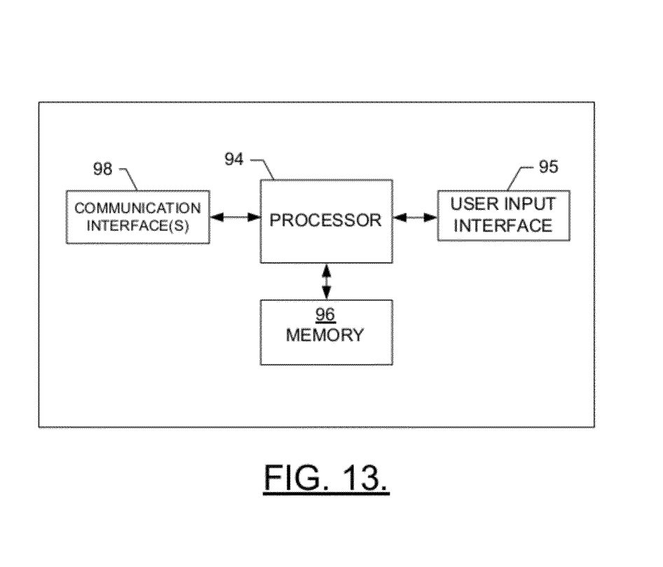

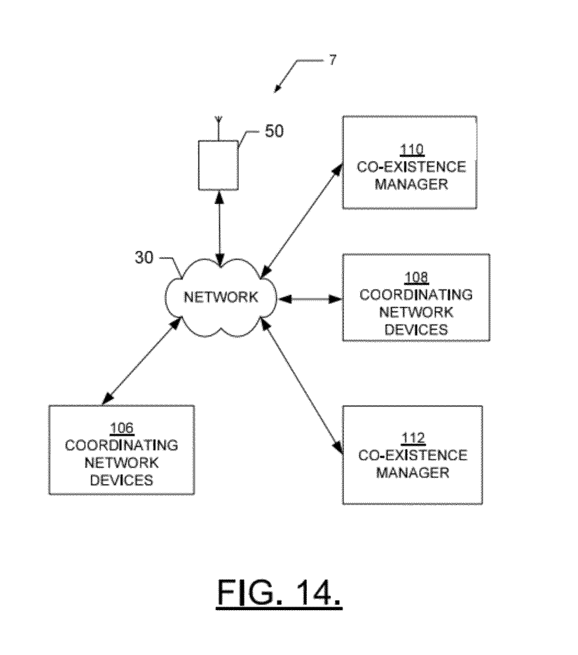

Referring now to FIG. 13, a block diagram of an example embodiment of a network entity is provided. As shown in FIG. 13, the network entity (e.g., an eNB or a coordinating network device 106, 108 or co-existence manager 110, 112 of FIG. 14) generally includes a processor 94 and an associated memory 96. The memory 96 (also referred to herein as database 96) may comprise volatile and/or non-volatile memory, and may store content, data and/or the like. For example, the memory may store content, data, information, and/or the like transmitted from, and/or received by, the network entity. Also for example, the memory 96 may store client applications, instructions, and/or the like for the processor 94 to perform the various operations of the network entity in accordance with embodiments of the invention, as described above.

In an example embodiment, database 96 may store information associated with one or more white space frequencies, unlicensed frequencies and any other frequency (e.g., cellular frequencies) related information or other information. For instance, the database 96 may include information identifying whether white space frequency and/or unlicensed frequencies are available in one or more particular locations (e.g., a current location of an apparatus 50, a predicted or future location of an apparatus 50, a current location of an apparatus 50 of other users (e.g., friends), etc.). Additionally, the database 96 may include information indicating times that a primary user(s) (e.g., TV broadcaster, etc.) may be authorized to utilize frequency spectrums and other times that secondary users (e.g., a user of apparatus 50) may be allowed to utilize frequency spectrum associated with the database 96. In this regard, processor 94 may analyze the database 96 and may provide some guidance to the deactivation module 78 as to the manner in which the apparatus 50 may be allowed to utilize the frequency spectrum associated with the database 96. For instance, the database 96 may store information indicating that secondary users should utilize the frequency spectrum within certain power limits or within other suitable parameters.

In addition to the memory 96, the processor 94 may also be connected to at least one interface or other means for displaying, transmitting and/or receiving data, content, and/or the like. In this regard, the interface(s) may comprise at least one communication interface 98 or other means for transmitting and/or receiving data, content, and/or the like, as well as at least one user input interface 95. The user input interface 95, in turn, may comprise any of a number of devices allowing the network entity to receive data from a user, such as a keypad, a touch display, a joystick or other input device. In this regard, the processor 94 may comprise user interface circuitry configured to control at least some functions of one or more elements of the user input interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

In one example embodiment, in response to the deactivation module 78 determining that a secondary cell (e.g., secondary cell 132) is to be deactivated, in the manner described above, the deactivation module 78 may continue to obtain measurements (e.g., a SINR below a predetermined threshold, a power level below a predetermined) related to the secondary cell. For example, in an instance in which the secondary cell remains in a Carrier Aggregation configuration list, the deactivation module 78 may continue to obtain one or more measurements associated with the secondary cell. In this regard, for example, the measurements may be utilized to enable the deactivation module 78 to determine whether the apparatus 50 may be connected to the secondary cell some time in the future.

In another example embodiment, in an instance in which the deactivation module 78 may determine that a secondary cell is to be deactivated, the deactivation module 78 may modify a corresponding Carrier Aggregation (CA) configuration list and may remove the secondary cell from the CA configuration list. In response to removing the secondary cell from the CA configuration list, the deactivation module 78 may not obtain measurements associated with the secondary cell. As such, a network device (e.g., network device 120) may not configure one or more measurement objects for the corresponding secondary cell. In other words, in an instance in which the secondary cell is deactivated, measurements on the corresponding secondary cell may be automatically stopped without the need for the network device to remove and/or configure the secondary cell. In this manner, by removing the secondary cell from the CA configuration list, the deactivation module 78 and/or the network device (e.g., network device 120) may conserve measurement power and may minimize the burden in obtaining the measurements associated with the secondary cell. This may be beneficial in order to free resources (e.g., processing resources, memory resources, etc.) of the apparatus 50 to perform other tasks.

Referring now to FIG. 14, a system for determining whether to deactivate a secondary cell according to an example embodiment is provided. The system of FIG. 14 may be beneficial, for example, to provide an efficient and reliable manner in which a communication device utilizing the secondary cell may initiate the decision as to whether the secondary cell should be deactivated. The system 7 may include co-existence managers 110, 112 (also referred to herein as white space (WS) controlling devices 110, 112) and coordinating network devices 106, 108 (also referred to herein as coordinating databases 106, 108 or WS databases 106, 108). Although system 7 shows one apparatus 50 (e.g., mobile terminal 10, UE 104), two co-existence managers 110, 112 (e.g., second communication device 20) and two coordinating network devices 106, 108 (e.g., third communication device 25), it should be pointed out that the system 7 may include any suitable number of apparatuses 50, co-existence managers 110, 112 and coordinating network devices 106, 108 without departing from the spirit and scope of the invention.

The co-existence managers 110, 112 may manage and control secondary users or any users at the same hierarchy or level. For example, the co-existence managers may control a common usage of frequency spectrum with a controlling architecture or infrastructure. The co-existence managers 110, 112 may manage the co-existence of devices utilizing or co-sharing a common frequency spectrum (e.g., white space frequency, unlicensed frequency, etc.). The co-existence managers 110, 112 may access information in a memory (e.g., memory 96) and may utilize this information to determine what kind of devices there are in that local space that they are managing and may determine the manner in which the devices are to utilize the frequency spectrum.

As an example, for purposes of illustration and not of limitation, consider an instance in which the apparatus 50 may be utilizing some frequency spectrum (e.g., white space frequency spectrum) locally, for example, within a secondary cell. In this regard, the apparatus 50 may need to be in connection with a co-existence manager managing the usage of the frequency spectrum. A co-existence manager (e.g., co-existence manager 110) may inform the apparatus 50 that there is some situation (e.g., emergency calls, etc.) requiring usage of the entire frequency spectrum. In this manner, the co-existence manager (e.g., co-existence manager 110) may instruct the apparatus 50 to stop using the frequency spectrum. As such, the deactivation module 78 of the apparatus 50 may determine that the frequency spectrum should be released and no longer utilized until the co-existence manager instructs the deactivation module 78 that it may use the frequency spectrum again.

One or more of the coordinating network devices 106, 108 may receive a request(s) from the deactivation module 78 for data indicating whether there is frequency spectrum (e.g., white space frequency) available in a particular location such as, for example, a location associated with a secondary cell (e.g., secondary cell 132). In an instance in which a processor (e.g., processor 94) of a coordinating network device (e.g., coordinating network device 106) may examine a database (e.g., database 96) and may determine that there is frequency spectrum available in the location for secondary use, the processor may send a message to the deactivation module 78 informing the deactivation module 78 that frequency spectrum is available. The deactivation module 78 may determine that the frequency spectrum associated with the location (e.g., a location within a secondary cell) should be utilized by the apparatus 50.

On the other hand, the processor (e.g., processor 94) of the coordinating network device may send a message to the deactivation module 78 informing the deactivation module 78 that there is no frequency spectrum available for secondary use in the particular location in response to examining the database (e.g., database 96) and determining that there is no frequency spectrum available for secondary use in the particular location.

Additionally or alternatively, in an instance in which the deactivation module 78 initially received a message from the processor of the coordinating network device (e.g., coordinating network device 106) indicating that frequency spectrum was available for secondary use in a particular location, and the processor subsequently determines that the frequency spectrum is no longer good for use, the processor of the coordinating network device may send a message to the deactivation module 78. The message may indicate that the frequency spectrum is no longer good for use. In this regard, the deactivation module 78 may determine that the apparatus 50 should be deactivated from a secondary cell associated with the particular location and that the frequency spectrum of the secondary cell should no longer be utilized by the apparatus 50.

In one example embodiment, the deactivation module 78 may send a message (e.g., deactivation message) to a network device (e.g., base station 120), or another network element, to deactivate the apparatus 50 from the secondary cell. As such, the network device (e.g., base station 120) may deactivate the apparatus 50 from the secondary cell. In an instance in which the network device may deactivate the apparatus 50 from the secondary cell, the network device may transfer data from the secondary cell to a primary cell (e.g., primary cell 130). A memory (e.g., memory 96) of a coordinating network device (e.g., coordinating network device 106) may include information such as, for example, the location and availability of one or more channels and/or corresponding frequency spectrum at specific geographical locations for a certain area (e.g., a city, a country, etc.). This information may be utilized by the deactivation module 78 to enable the deactivation module 78 to better understand the needs to deactivate a secondary cell.

The system 7 may also include one or more Access Network Discovery and Selection Functions ANDSFs (not shown). In this regard, the deactivation module 78 may communicate with at least one ANDSF for information indicating the availability of frequency spectrum in a secondary cell, for example. The deactivation module 78 may utilize the information obtained for the ANDSF to determine whether the apparatus 50 should be deactivated from a secondary cell and may release the frequency spectrum (e.g., white space frequency, unlicensed frequency, etc.) associated with the secondary cell. The ANDSF may include location and time dependent information about the availability of frequencies. Additionally, the ANDSF may PUSH Management Object to a device. The device may also obtain the Management Object from its own initiative by PULL action. The trigger to execute the Management Object may be based on the device location, time, an update in the loaded object, for example, or in any other suitable manner. The execution of the ANDSF may be implemented as a markup script such as Extensible Markup Language (XML), for example. In an example embodiment, ANDSF objects may be compatible to the Device Management objects defined by Open Mobile Alliance (OMA).

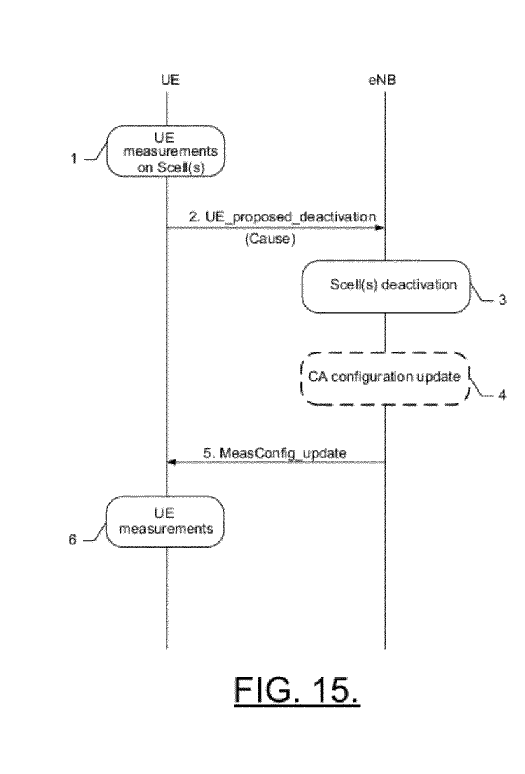

Referring now to FIG. 15, a signal flow for determining whether a secondary cell(s) should be deactivated according to an example embodiment is provided. At operation 1, the UE (e.g., apparatus 50 (e.g., UE 104)) may obtain one or more measurements (e.g., a sensed primary user measurement, a sensed disturbance measurement, etc.) of a secondary cell(s) (e.g., secondary cell 132). The one or more measurements may indicate a disturbance or interference within the secondary cell(s). In this regard, the UE may generate a deactivation message to deactivate the secondary cell(s) and no longer use the frequency spectrum of the secondary cell(s). At operation 2, based in part on the measurement(s), the UE may send the deactivation message to a network device such as, for example, an eNB (e.g., base station 120). The deactivation message may include a proposal for deactivating a secondary cell(s) and releasing the usage of the frequency spectrum of the secondary cell(s). The deactivation message generated by the UE may include a cause field (also referred to herein as a reason field). The cause field may include reasons as to why the UE is requesting deactivation of a secondary cell(s). The cause field may also include the measurement(s) indicating the disturbance within the secondary cell(s) that may trigger the UE to generate the deactivation message. For purposes of illustration and not of limitation, the UE may include data in the cause field indicating the desire of the UE to save power or energy in obtaining measurements. As such, even if the frequency spectrum of the secondary cell(s) is usable, the eNB may decide to deactivate the secondary cell(s) so that the UE may minimize power resources or energy resources in making measurements associated with the secondary cell(s).

In an alternative example embodiment, the UE may send the deactivation message to any other suitable network entity. At operation 3, the eNB may determine to deactivate the secondary cell(s). In an example embodiment in which the UE may send the deactivation message to another network entity, the network entity receiving the deactivation message may determine to deactivate the secondary cell(s). Alternatively, the UE may make a decision to enable automatic deactivation of the secondary cell(s) in response to the UE sending the deactivation message to the eNB. For example, the UE may include a cause-field in the deactivation message that may be sent to the eNB indicating to the eNB that the secondary cell(s) is to be deactivated. The cause-field in the deactivation message may specify one or more pre-defined reasons for deactivation which when received by the eNB may cause or trigger the eNB to automatically deactivate the secondary cell(s). In this regard, in an instance in which the eNB determines that one or more predetermined reasons for deactivation are specified in the deactivation message, the eNB may automatically deactivate the secondary cell(s). Examples of reasons for deactivation may include, but are not limited to: authority requirement to release the use of that frequency; too high primary user interference generation; entering a prohibited location for that frequency; time of that frequency's use becoming unavailable; too high or not practical level of interference detected on the frequency; a coexistence condition(s) towards another device; energy consumption of measurements for SCELL operation is not tolerable; energy consumption of SCELL data transfer is not tolerable; cost of SCELL use becomes somehow unfavourable; authorization or security of the SCELL becomes untrusted. In an example embodiment, the kinds of reasons for deactivation may be defined, for example, as follows:
Cause{authority-requirement, interference-level, coexistence condition, energy saving, trust, cost}. Some of these reasons may lead to an immediate and definite deactivation of the SCELL. Additionally or alternatively, some of these reasons may be informative and may leave the actual decision of deactivation to a network device (e.g., an eNB).

Deactivation of the secondary cell(s) by the eNB may have implications on the network. For example, deactivation of a secondary cell(s) by the eNB may trigger the eNB to perform bearer management and/or traffic management actions, or any other suitable actions. For instance, the eNB may determine that deactivation of a secondary cell(s) caused a throughput in the network to be low and as such a high bit rate bearer may need to be scaled down, which may have an impact on traffic in the network.

Optionally, at operation 4, the eNB may, but need not, update a Carrier Aggregation (CA) configuration. In this regard, the eNB may, but need not, remove the secondary cell(s) from a CA configuration list or set (e.g., a WS_deconf{List[unsuitable Scells]} list). Optionally, at operation 5, the eNB may send a measurement configuration update message to the UE. The measurement configuration update message may specify to the UE the measurements to obtain in a primary cell and/or a secondary cell(s). In an instance in which the eNB may remove the secondary cell(s) from a CA configuration list or set, the measurement configuration update message may not include any measurements to be taken in the secondary cell. However, the measurement configuration update message may specify to perform measurements in a primary cell.

On the other hand, in an instance in which the secondary cell(s) remains in the CA configuration list or set, the measurement configuration update message may include instructions to obtain measurements in the primary cell and/or the secondary cell(s). In an instance in which the eNB may remove secondary cell(s) from a CA configuration list or set, the eNB may instruct the UE to search for other opportunities of establishing a connection with other secondary cells and in this regard the measurement configuration update message may specify one or more measurements to be obtained in these other secondary cells. In this regard, the eNB may generate a new CA configuration list or set based on these identified secondary cells or the eNB may update an existing CA configuration list or set to include information specifying these identified secondary cells. At operation 6, the UE may perform the measurements specified by the eNB in the measurement configuration update message. Additionally, the UE may perform measurements specified by the UE.

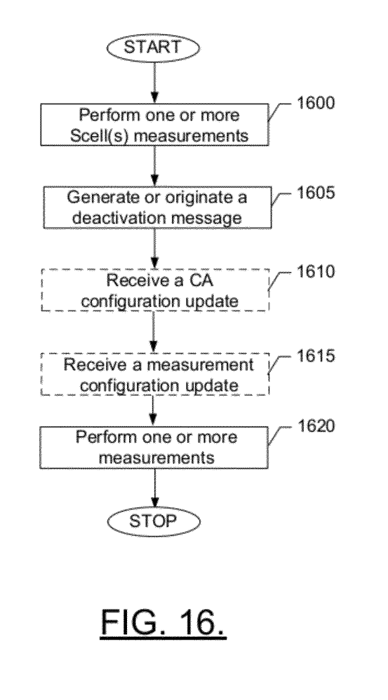

Referring to FIG. 16, a flowchart of a method for deactivating a secondary cell(s) according to an example embodiment is provided. At operation 1600, an apparatus (e.g., apparatus 50 (e.g., UE 104)) may obtain one or more measurements associated with a secondary cell(s) (e.g., secondary cell 132). At operation 1605, the apparatus may generate a deactivation message to deactivate a secondary cell(s), in response to determining that at least one of the measurements indicated a disturbance or interference within the secondary cell(s). Additionally or alternatively, the apparatus may generate the deactivation message in response to receipt of data (e.g., one or more notifications) from one or more devices (e.g., coordinating network devices 106, 108, co-existence managers 110, 112) indicating information regarding the use of frequency spectrum in a secondary cell(s).

Optionally, at operation 1610, the apparatus may receive an updated CA configuration (e.g., an updated CA configuration list or set) from a network device (e.g., an eNB (e.g., base station 120)). The updated CA configuration may be received by the apparatus from the network device in a Radio Resource Control (RRC) Configuration (RRCConfig) message. The network device may, but need not, remove the secondary cell(s) (e.g., removal of the secondary cell from a WS_deconf{List[unsuitable Scells]} list of a CA configuration) from the updated CA configuration. In this regard, the apparatus may not need to perform any measurements within or associated with the secondary cell(s). Optionally, at operation 1615, the apparatus may receive an updated measurement configuration (MeasConfig) message (e.g., an RRC message) from the network device. The updated measurement configuration message may include data instructing the apparatus to perform one or more measurements associated with a primary cell (e.g., primary cell 130) and/or a secondary cell(s). In an instance in which the received updated CA configuration does not include the secondary cell(s), the updated measurement configuration message may not include data instructing the apparatus to perform measurements associated with the secondary cell(s). At operation 1620, the apparatus may perform the measurements specified by the network device in the updated measurement configuration message as well as its own specified measurements.

In one example embodiment of the invention, a device such as, for example, a UE with reduced capabilities may be provided. This kind of UE may be a user device or a machine. Such a device may operate with relaxed requirements on a set of frequencies, for example, such as f1 and f2 so that f1 is always the PCELL and f2 is used as a SCELL in certain locations only. This way the device may not need to run many measurements for the SCELL operation, but the SCELL can be activated and deactivated based on the location information alone, or by other means described herein. In this manner, the device may collect information and may stay in contact to the network via f1, and once reaching (or parking) a location with f2, the device may load its collected information to the network more efficiently. Similarly, also vice versa, if the device is configured for certain operation, it may be more efficient to load the configuration from the network when both f1 and f2 are available as compared to a location with f1 alone.

In this example embodiment, f1 and f2 are known fixed frequencies for this kind of operation, hence the device implementation may be simplified, and a large set of measurements and flexibility complexity may be avoided. In addition, this operation may be extensible to any set of known frequencies in addition to f1 and f2. Power consumption may also be minimal due to this simplified operation of ON/OFF SCELL as a function of location.

It should be pointed out that FIGS. 15 and 16 are flowcharts of a system, method and computer program product according to an example embodiment of the invention. It will be understood that each block of the flowcharts, and combinations of blocks in the flowcharts, may be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by one or more memory devices (e.g., memory device 76, memory 96) and executed by one or more processors (e.g., processor 77, deactivation module 78, processor 94). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the method of FIGS. 15 and 16 above may comprise one or more processors (e.g., the processor 77, the deactivation module 78, the processor 94) configured to perform some or each of the operations (1-6 and 1600-1620) described above. The processor may, for example, be configured to perform the operations (1-6 and 1600-1620) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (1-6 and 1600-1620) may comprise, for example, the processor 77 (e.g., as means for performing any of the operations described above), the deactivation module 78, the processor 94 and/or a device or circuit for executing instructions or executing an algorithm for processing information as described above.

The present invention may be applicable to cellular or mobile telecommunication systems defined above but also to other suitable telecommunication systems. The protocols used, the specifications of cellular telecommunication systems, their network elements and subscriber terminals, develop rapidly. Such development may require extra changes to the described embodiments. Therefore, all words and expressions should be interpreted broadly and they are intended to illustrate, not to restrict, the embodiments. It will be obvious to a person skilled in the art that, as technology advances, the inventive concepts may be implemented in various ways.

As such, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining, via a processor, that at least one secondary cell is to be deactivated based at least in part on at least one measurement of the secondary cell or receipt of information associated with a frequency spectrum of the secondary cell;
generating a deactivation message in response to the measurement indicating an interference with the secondary cell or the received information indicating that the frequency spectrum should no longer be used by a first device; and
enabling provision of the deactivation message to a network device.

2. The method of claim 1, wherein:
enabling provision of the deactivation message to the network device comprises enabling the network device to determine whether to deactivate the secondary cell, the frequency spectrum relates to one or more frequencies outside one or more dedicated frequencies of a cellular network; and
the frequency spectrum comprises at least one of a white space frequency spectrum or an unlicensed frequency spectrum.

3. The method of claim 2, further comprising:
receiving a first message indicating that the secondary cell is deactivated in response to a determination by the network device to deactivate the secondary cell; and
utilizing at least one of the dedicated frequencies in response to the receipt of the first message, wherein the dedicated frequency is provided by at least one primary cell.

4. The method of claim 3, wherein deactivate the secondary cell comprises discontinuing use of the frequency spectrum of the secondary cell, and the method further comprises:
continuing to perform one or more measurements on the secondary cell even though the secondary cell is deactivated.

5. The method of claim 3, wherein the first message comprises a Carrier Aggregation configuration message indicating a plurality of frequencies that are aggregated for usage by the first device, the plurality of frequencies comprise at least one of a white space frequency, a cellular frequency or an unlicensed frequency.

6. The method of claim 2, wherein receipt of information associated with the frequency spectrum comprises receiving the information from one or more devices, the information including data specifying one or more instances or times in which the frequency spectrum is usable by the first device or at least one instance in which the first device is prohibited from using the frequency spectrum due to a priority of use by a primary user of the frequency spectrum.

7. The method of claim 2, wherein generating the deactivation message comprises including content in the deactivation message indicating to the network device to automatically deactivate the secondary cell on the basis of the content in the deactivation message without making an independent determination as to whether to deactivate the secondary cell.

8. An apparatus comprising:
at least one processor; and
at least one memory including computer program code, the at least one memory and the computer program code configured to, with the at least one processor, cause the apparatus to perform at least the following:
determine that at least one secondary cell is to be deactivated based at least in part on at least one measurement of the secondary cell or receipt of information associated with a frequency spectrum of the secondary cell;
generate a deactivation message in response to the measurement indicating an interference with the secondary cell or the received information indicating that the frequency spectrum should no longer be used by the apparatus; and
enable provision of the deactivation message to a network device.

9. The apparatus of claim 8, wherein the at least one memory and the computer program code are further configured to, with the processor, cause the apparatus to:
enable provision of the deactivation message to the network device by enabling the network device to determine whether to deactivate the secondary cell, the frequency spectrum relates to one or more frequencies outside one or more dedicated frequencies of a cellular network,
wherein the frequency spectrum comprises at least one of a white space frequency spectrum or an unlicensed frequency spectrum.

10. The apparatus of claim 9, wherein the apparatus comprises a mobile terminal and the network device comprises a base station.

11. The apparatus of claim 9, wherein the at least one memory and the computer program code are further configured to, with the processor, cause the apparatus to:
receive a first message indicating that the secondary cell is deactivated in response to a determination by the network device to deactivate the secondary cell; and
utilize at least one of the dedicated frequencies in response to the receipt of the first message, wherein the dedicated frequency is provided by at least one primary cell.

12. The apparatus of claim 11, wherein the at least one memory and the computer program code are further configured to, with the processor, cause the apparatus to:
deactivate the secondary cell by discontinuing use of the frequency spectrum of the secondary cell; and
continue to perform one or more measurements on the secondary cell even though the secondary cell is deactivated.

13. The apparatus of claim 11, wherein the first message comprises a Carrier Aggregation configuration message indicating a plurality of frequencies that are aggregated for usage by the apparatus, the plurality of frequencies comprise at least one of a white space frequency, a cellular frequency or an unlicensed frequency.

14. The apparatus of claim 13, wherein the at least one memory and the computer program code are further configured to, with the processor, cause the apparatus to:
discontinue the measurements associated with the secondary cell in response to the secondary cell being removed from the Carrier Aggregation configuration message.

15. The apparatus of claim 9, wherein the at least one memory and the computer program code are further configured to, with the processor, cause the apparatus to:
receive a second message indicating whether to perform one or more measurements on at least one of a primary cell or the secondary cell; and
obtain the measurements in response to receipt of the second message.

16. The apparatus of claim 9, wherein the at least one memory and the computer program code are further configured to, with the processor, cause the apparatus to:
facilitate receipt of the information associated with the frequency spectrum by receiving the information from one or more devices, the information comprising data specifying one or more instances or times in which the frequency spectrum is usable by the apparatus or at least one instance in which the apparatus is prohibited from using the frequency spectrum due to a priority of use by a primary user of the frequency spectrum.

17. The apparatus of claim 9, wherein the at least one memory and the computer program code are further configured to, with the processor, cause the apparatus to:
generate the deactivation message by including content in the deactivation message indicating to the network device to automatically deactivate the secondary cell on the basis of the content in the deactivation message without making an independent determination as to whether to deactivate the secondary cell.

18. An apparatus comprising:
at least one processor; and
at least one memory including computer program code, the at least one memory and the computer program code configured to, with the at least one processor, cause the apparatus to perform at least the following:
receive a deactivation message from a device, the deactivation message is generated in response to at least one measurement indicating an interference with a secondary cell or receipt of information indicating that a frequency spectrum of the secondary cell should no longer be used by the device; and
determine whether to deactivate the secondary cell based in part on the received deactivation message.

19. The apparatus of claim 18, wherein:
the frequency spectrum relates to one or more frequencies outside one or more dedicated frequencies of a cellular network; and
the frequency spectrum comprises at least one of a white space frequency spectrum or an unlicensed frequency spectrum.

20. The apparatus of claim 19, wherein the apparatus comprises a network device and the device comprises a mobile terminal.
